(19) United States
(12) Patent Application Publication
(10) Pub. No.: US 2010/0213417 A1
(43) Pub. Date: Aug. 26, 2010

(54) Process and catalyst for hydrocarbon conversion

(76) Inventors: Yazhong Chen, Dalian (CN); Andreas Josef Goldbach, Dalian (CN); Yuzhong Wang, Dalian (CN); Hengyong Xu, Dalian (CN)

Correspondence Address: NIXON & VANDERHYE, PC, 901 NORTH GLEBE ROAD, 11TH FLOOR, ARLINGTON, VA, 22203, US

(21) Appl. No.: 12/311,970

(22) PCT Filed: Oct. 23, 2006
(86) PCT No.: PCT/CN2006/002829

§ 371 Date: Jun. 11, 2009

(51) Int. Cl. C01B 3/40; B01J 23/10; B01J 23/755

(52) U.S. Cl. 252/373; 502/302; 502/303

(57) ABSTRACT

A process for the conversion of hydrocarbons to hydrogen and one or more oxides of carbon, comprising contacting the hydrocarbon with steam and/or oxygen in the presence of a spinel-phase crystalline catalyst comprising a catalytically active metal. There is also described a method for making a catalyst suitable for the conversion of hydrocarbons to hydrogen and one or more oxides of carbon comprising adding a precipitant to a solution or suspension of a refractory oxide or precursor thereof and a catalyst metal-containing compound to form a precipitate which is calcined in an oxygen-containing atmosphere to produce a crystalline phase with a high dispersion of catalyst metal. There is further described a crystalline catalyst comprising the elements nickel, magnesium, aluminium and a lanthanide element, in which the crystalline phase is a spinel phase.

This invention relates to the field of catalysis, more specifically to an improved catalyst for converting a hydrocarbon to hydrogen and one or more oxides of carbon, and a method of producing improved catalysts.

Steam reforming or partial oxidation catalysts often comprise nickel supported on an oxide support. For example, U.S. Pat. No. 5,053,379 describes a catalyst comprising nickel supported on a magnesium oxide support for the steam reforming of methane. Often, the support is a combination of two or more refractory oxides, such as a combination of aluminium and lanthanum oxides.

EP-A-0 033 505 describes a catalyst comprising nickel oxide, a rare earth oxide and zirconium oxide, in which an aqueous solution of nitrates or acetates of the nickel, rare-earth and zirconium metals are precipitated with the hydroxide or nitrate of ammonium or sodium. Optionally, magnesium or aluminium oxides can be introduced into the catalyst composition by similar means.

In the Symposium on Advances in Fischer-Tropsch Chemistry, 219^{th} National Meeting, American Chemical Society, 2000, pp 270-1, Pacheco et al report that NiO/alpha-Al₂O₃ catalysts show improved catalytic activity towards methane partial oxidation when MgO is present. Mehr et al, in React. Kinet. Catal. Lett., 75(2), 267-273 (2002) additionally report that MgO-modified NiO/alpha-Al₂O₃ catalysts show improved resistance to coking in steam reforming reactions.

The presence in the catalyst of lanthanum oxide or titanium oxide in steam reforming reactions has also been shown to reduce coking of the catalyst, as reported by Pour et al, React. Kinet. Catal. Lett., 86(1), 157-162 (2005).

A problem with existing catalyst formulations is that catalytic activity tends to increase with catalyst loading only up to a certain extent. If the activity could be further increased with increasing catalyst metal loading, then improved conversions of hydrocarbons to hydrogen and one or more oxides of carbon could be achieved.

According to a first aspect of the present invention, there is provided a method of producing a steam reforming catalyst comprising the steps of:
(i) Providing a solution or suspension comprising a catalyst metal active for the conversion of a hydrocarbon to hydrogen and one or more oxides of carbon, and a refractory oxide or precursor thereof;
(ii) Producing a precipitate comprising the catalyst metal and refractory oxide;
(iii) Separating the precipitate of step (ii) from the solution or suspension; and
(iv) heating the separated precipitate of step (iii) under an oxygen-containing atmosphere to a temperature at which a crystalline phase is formed having highly dispersed catalyst metal;
   characterised in that the precipitate comprising catalyst metal and refractory oxide in step (ii) is obtained by treating the solution or suspension of step (i) with a precipitant.

Typical catalysts for converting hydrocarbons to hydrogen and oxides of carbon, such as alumina-supported nickel catalysts, are limited in the quantity of catalyst metal that can be supported. When the catalyst metal loading exceeds a certain value, the supported metal can tend to agglomerate to form large metal particles, which reduces the surface area of metal available for catalysis. In addition, high catalyst metal loadings can result in reduced crush strength characteristics, resulting in poor attrition resistance.

The inventors have now found that such problems can be avoided by producing a crystalline phase comprising highly dispersed catalyst metal, which enables the benefits of higher loadings of catalyst metal, such as improved catalytic activity, to be realised. A further advantage of the present invention is that high catalyst crush strength is achieved, which potentially imparts improved attrition resistance and can result in improved catalyst lifetime and less generation of catalyst fines. Catalyst strength can also remain unaffected even after reduction of the catalyst in which the catalyst metal is reduced to metal(0) species, which is advantageous in applications where exposure to reducing gases, such as hydrogen, are experienced, for example in steam reforming or partial oxidation reactions.

The method comprises providing a solution or suspension comprising a catalyst metal and a refractory oxide or precursor thereof. The catalyst metal can be introduced in the form of a soluble compound or salt, or as a suspension of a catalyst metal oxide. The refractory oxide support can also be present either as a colloid or suspension of refractory oxide particles, or in the form of a soluble compound that produces the refractory oxide on precipitation.

The solvent used to dissolve or suspend the catalyst metal and the refractory oxide or precursor compounds is suitably selected from one or more of water and a polar organic solvent. Typical polar organic solvents include: alcohols such as C₁ to C₄ alcohols such as ethanol or n- or iso-propanol, ethers such as diethyl ether or methyl tert-butyl ether, carboxylic acids such as acetic acid, propionic acid or butanoic acid, carboxylic acid esters such as methyl-, ethyl-, propyl-, or butyl acetate, and ketones such as acetone and methyl ethyl ketone. Typically, water is used.

In a preferred embodiment, both a catalyst metal-containing compound and a refractory oxide precursor compound are used, which are dissolved in a solvent. The catalyst metal-containing compound is typically selected from one or more of a carbonate, nitrate, sulphate, halide, alkoxide, carboxylate or acetate. Refractory oxide precursor compounds are typically those that are capable of producing the refractory oxide after treatment by, for example, calcination or precipitation with a base. Suitable compounds are selected from carbonate, nitrate, alkoxide, carboxylate or acetate salts, as they tend not to leave unwanted residues in the final catalyst composition after washing and calcination.

The catalyst metal is active for reactions that convert hydrocarbons to hydrogen and one or more oxides of carbon, such as carbon dioxide and carbon monoxide. Such reactions include steam reforming and partial oxidation. Catalysts suitable for one or more of these reactions typically include one or more of nickel, ruthenium, platinum, palladium, rhodium, rhenium and iridium. The refractory oxide is suitably selected from one or more of alumina, silica, zirconia and an alkaline earth metal oxide. The refractory oxide precursor, if used, is a compound that comprises the corresponding refractory oxide element. The catalyst metal-containing compound and refractory oxide or precursor thereof are mixed together to form a solution or suspension, for example a solution in water.

Optionally, the catalyst may also comprise one or more promoters, which may comprise one or more of an alkali metal or a lanthanide element. In one embodiment of the invention, a lanthanide element is used as a promoter, and in a further embodiment the promoter is lanthanum. The promoter can be added to the solution or suspension in the same way as the refractory oxide or precursor therefore, or the catalyst metal.

In a preferred embodiment of the present invention, the refractory oxide is alumina, and more preferably is a combination of alumina and magnesia. The catalyst preferably comprises lanthanum as a promoter.

A precipitant is added to the solution or suspension of step (i) in order to form a precipitate comprising the catalyst metal and refractory oxide, optionally in combination with additional components, such as promoters. It is preferred that the catalyst metal and optional additional components are finely dispersed within the refractory oxide such that, when the subsequent crystallisation step is performed, a high degree of crystalline homogeneity and dispersion of the catalyst metal within the crystalline structure is achieved.

The precipitant is added to the solution or suspension in order to produce a precipitate comprising the catalyst metal, the refractory oxide and any additional components, and is typically a base. Bases that can be employed, particularly for aqueous solutions, include ammonia, ammonium hydroxide or carbonate, or alkali metal or alkaline earth metal hydroxides or carbonates. Where the compounds are colloidal or soluble in the solvent, the precipitate is generally an amorphous, or poorly crystalline, mixed oxide. The precipitate can be separated from the solvent using typical techniques such as filtration or centrifugation.

The synthesis can be carried out under ambient conditions of temperature or pressure, or alternatively may be carried out under elevated temperature and pressure, for example by employing hydrothermal synthesis techniques using sealed, heated autoclaves. Co-precipitation techniques can be used, wherein in step (i) a refractory oxide precursor compound, a catalyst metal containing compound and an optional promoter-containing compound are present either as miscible liquids, or are dissolved in a solvent to form a homogeneous liquid phase, before the precipitant is added. This provides an even dispersion of the catalyst metal and optional promoter elements throughout the subsequently formed precipitate, which in turn provides improved dispersion throughout the resulting catalyst after the calcination in an oxygen-containing atmosphere.

After an optional washing step, the precipitate can be calcined under an oxygen-containing atmosphere. The calcination temperature is sufficient to convert the precipitate into a crystalline phase which incorporates the elements of the refractory oxide and any additional components that may have been added, and results in the catalyst metal being highly dispersed throughout the structure. The catalyst metal can be incorporated into lattice sites of the crystalline structure and/or can be dispersed across the surface of the crystalline phase in the form of nano-particles comprising the catalyst metal. In a preferred embodiment, catalyst metal-containing particles that may be present on the surface of the crystalline structure after calcination are less than about 4 nm in diameter.

Typically the calcination temperature will be in excess of 700° C., such as in the range of from 850 to 950° C. The oxygen-containing atmosphere can be air, or a gas richer or poorer in oxygen than air. The oxygen concentration and temperature are typically high enough to remove traces of unwanted components, such as residues of nitrate, acetate, alkoxide, alkyl and the like.

In a preferred embodiment of the invention, in which alumina is the refractory oxide, the crystalline phase is a spinel structure having the general formula AB₂O_{(4-δ)}. The spinel structure is based on naturally occurring spinel of formula MgAl₂O₄, in which A (Mg) and B (Al) represent different lattice sites, which can be substituted with heteroatoms. Spinel structures are well known in the art.

Before calcination, a layered double hydroxide phase can be formed, which typically comprises cationic layers having anions that lie between the layers. An example of a LDH is hydrotalcite, based on the general formula Mg₆Al₂(OH)₆CO₃.4H₂O. LDH's typically convert to other crystalline structures, for example spinel structures, when calcined at sufficiently high temperature.

In one embodiment of the invention, an additional step is provided before calcination, in which an additional component can be added to the precipitate resulting from step This can be used where the washing procedure in step (iii) can result in loss of a catalyst component. Thus, by adding the component after washing, its loss can be reduced while ensuring it can still be incorporated into the structure during calcination. The subsequently added component can be incorporated by mixing the precipitate with a suspension or solution of the additional component, and allowing the mixture to dry. This procedure is suitable for incorporating magnesium, optionally and preferably in the form of magnesium oxide, into the catalyst formulation, for example, which can otherwise often leach out of the precipitate during precipitation and/or washing if it is added in the initial solution or suspension comprising the catalyst metal and refractory oxide or precursor thereof. In one embodiment, the washed precipitate comprising the catalyst metal and the refractory oxide (for example aluminium oxide) is suspended in water, followed by the addition of a magnesium compound selected from one or more of magnesium carbonate, magnesium nitrate, magnesium oxide or magnesium hydroxide, preferably magnesium carbonate. The resulting suspension is dried, and the remaining solid calcined.

The catalyst produced in the present invention is suitable for reactions in which a hydrocarbon is converted to hydrogen and one or more oxides of carbon. Thus, according to a second aspect of the present invention, there is provided a process for the conversion of a hydrocarbon to hydrogen and one or more oxides of carbon comprising contacting the hydrocarbon and either steam or oxygen or both with a catalyst, which catalyst comprises a catalyst metal active for the conversion of the hydrocarbon to hydrogen and oxides of carbon, and a refractory oxide, characterised in that the catalyst has a spinel structure.

Partial oxidation or steam reforming of hydrocarbons, for example methane, are examples of processes that result in the production of hydrogen and one or more oxides of carbon. The catalyst metal is typically reduced to a metal(0) species in order to ensure sufficient catalytic activity. The loading of the catalyst metal can be tailored depending on the extent of activity required. The catalyst metal can be reduced either prior to being used in the reaction, or alternatively can be reduced within the reactor in which the reaction is to take place. Reduction is typically achieved by heating the catalyst under a hydrogen-containing atmosphere.

In a preferred embodiment of the invention, the catalyst is used in the steam reforming of methane. High temperature steam reforming reactions typically take place at temperatures of 800° C. or more, such as in the range of 950 to 1100° C. Low temperature steam reforming is carried out under milder conditions, typically at temperatures of 700° C. or less, such as 600° C. or less. Pressures in steam reforming reactions are typically in the range of up to 200 bara (20 MPa), for example from 1 to 200 bara (0.1 to 20 MPa), or 1 to 90 bara (0.1 to 9 MPa), such as 5 to 60 bara (0.5 to 6 MPa). Where the catalyst is used for low temperature steam reforming, it is preferably reduced by hydrogen before being used as catalyst, as the low temperature steam reforming reactor may not reach the temperatures required to reduce the catalyst metal to metal(0) species. Reduction temperatures are typically above 700° C., for example in the range of from 750 to 950° C.

Preferably, the catalyst metal is nickel and the refractory oxide is alumina in combination with magnesium oxide. Yet more preferably, a lanthanum promoter is also present. The presence of magnesium oxide and/or lanthanum in combination with alumina in the catalyst benefits hydrocarbon conversions in steam reforming reactions.

With catalysts such as nickel on alumina, increasing the nickel loading beyond a certain value tends not to result in any improved catalyst activity. Thus, maximum activity is typically observed at nickel loadings of less than 15 wt %. One reason for this is the migration and aggregation of nickel particles on the alumina surface at higher nickel loadings, which form relatively large particles with low surface area. This effect is exacerbated by conversion of the alumina to a low surface area alpha-alumina phase at temperatures typically experienced during partial oxidation or steam reforming. In the present invention, however, the catalyst metal atoms are highly dispersed throughout the spinel structure and/or along the surface of the spinel, which maintains a high surface area during synthesis and under reaction conditions. This allows high dispersion of catalyst metal to be maintained at high temperatures, which reduces agglomeration of catalyst metal-containing particles and results in catalysts with higher activity. It also causes the activity to level-off or plateau at higher loadings of catalyst metal, which further extends the scope for increasing catalyst activity.

According to a third aspect of the present invention, there is provided a catalyst composition suitable for the conversion of a hydrocarbon to hydrogen and one or more oxides of carbon, which catalyst is crystalline and comprises the elements nickel, magnesium, aluminium and a lanthanide element, characterised in that the crystalline phase is a spinel phase.

In catalysts according to the present invention, catalytic activity towards steam reforming increases with nickel loading to values above 15 wt %, and continues increasing with nickel loading up to a value of approximately 25% or 26% by weight. Above this loading, the activity tends to plateau.

The nickel content of the catalyst is preferably maintained in the region of from above 15% to 35% by weight, and more preferably in the range of from above 15 wt % to 26 wt %, for example in the range of from above 15% to 25% by weight, such as in the range of from 20 to 25% by weight.

The aluminium content, expressed as wt % of Al₂O₃ is suitably in the range of from 10 to 90% by weight, for example in the range of from 20 to 80% by weight, such as in the range of from 40% to 70% by weight.

The lanthanum content, expressed as wt % La₂O₃ is preferably above 0.1 wt %, for example above 1 wt %, and preferably in the range of from 2 to 12 wt %.

Magnesium, expressed as wt % MgO, is suitably present at a loading of above 5 wt %, typically being present at a loading of in the range of from 6 to 25 wt %, preferably in the range of from 6.5 to 20 wt %.

The invention will now be illustrated by the following non-limiting Examples and by the Figures, in which:

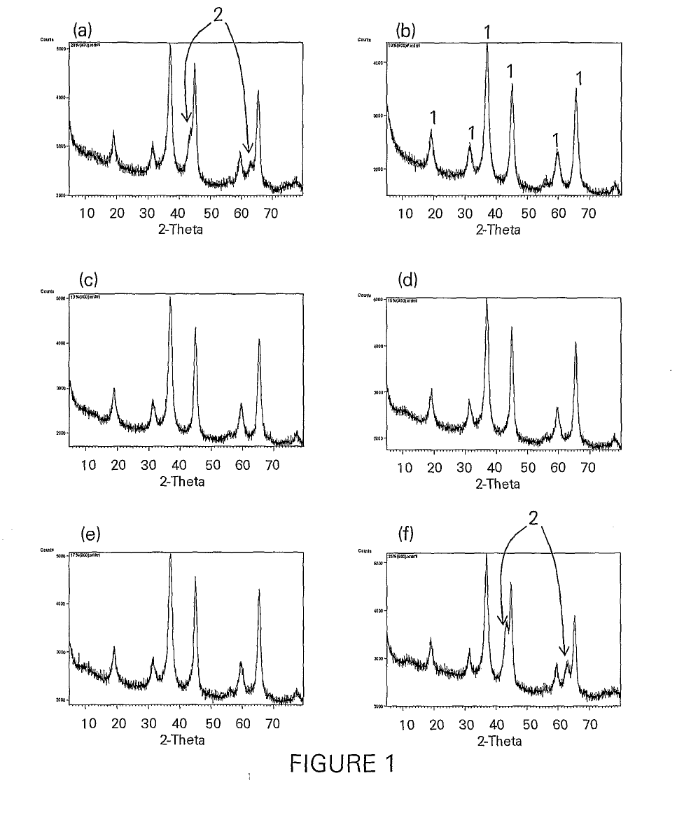

FIG. 1 shows X-ray diffraction patterns of calcined catalysts in accordance with the present invention;

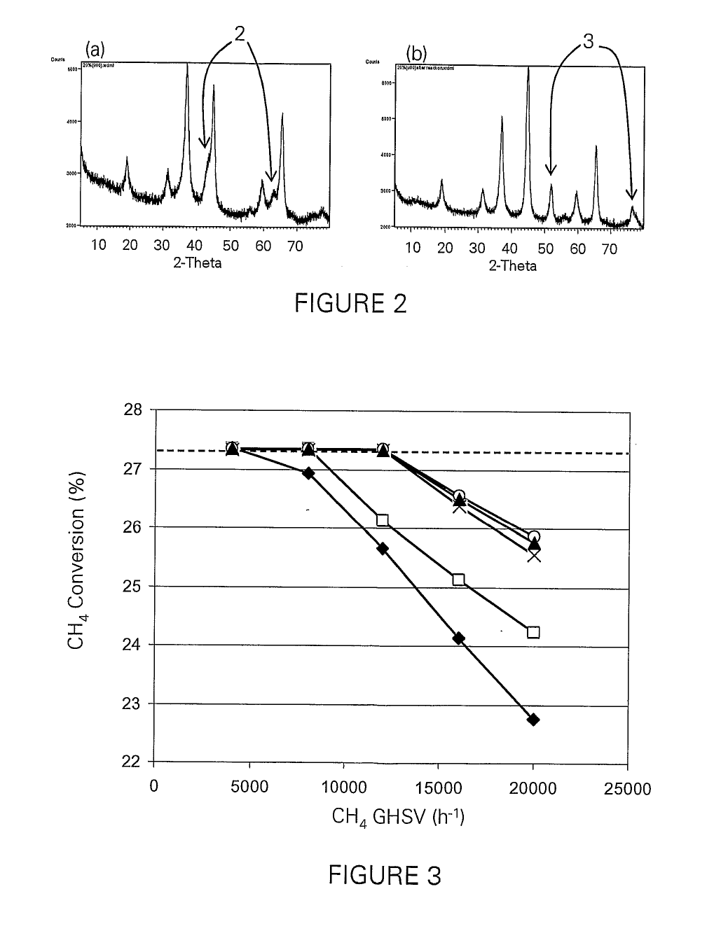

FIG. 2 shows X-ray diffraction patterns comparing a calcined catalyst of the present invention and the same catalyst after use in a steam reforming reaction.

FIG. 3 is a plot of methane conversions in the presence of catalysts having different nickel content;

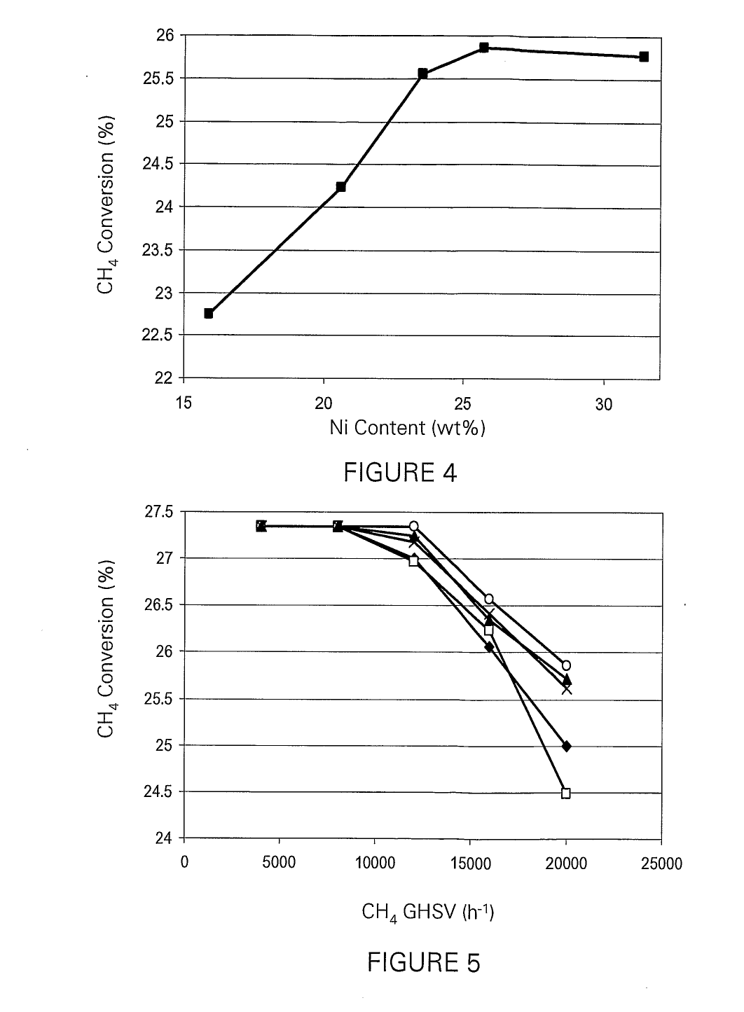

FIG. 4 is a plot of catalytic activity versus nickel content;

FIG. 5 is a plot of methane conversions in the presence of catalysts having different magnesium content;

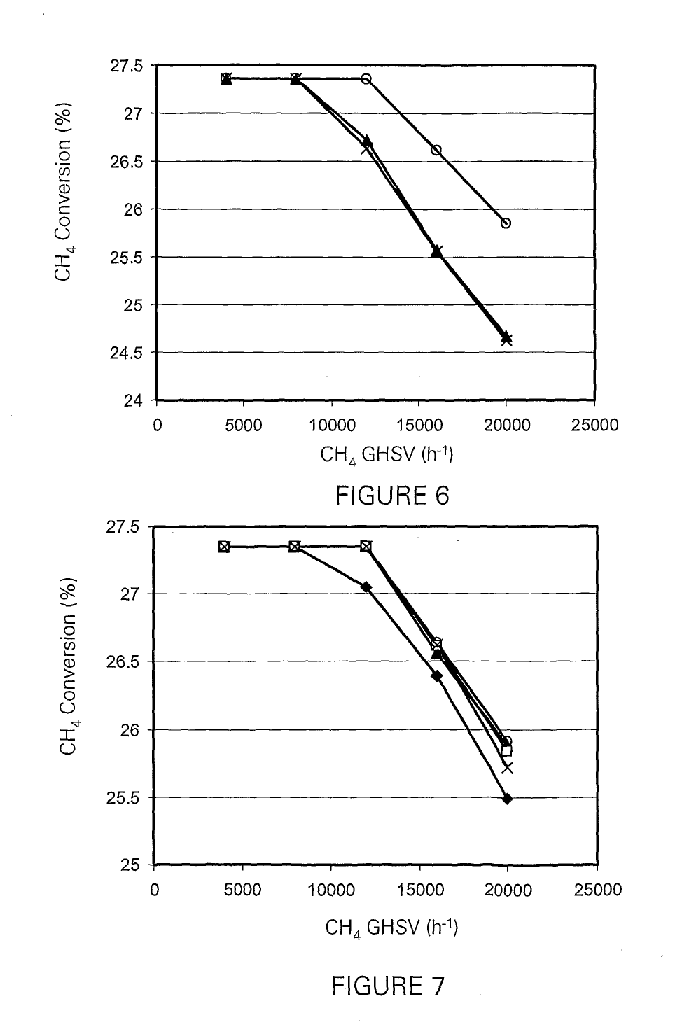

FIG. 6 is a plot of methane conversions in the presence of magnesium containing catalysts, in which different magnesium compounds were used during catalyst synthesis;

FIG. 7 is a plot of methane conversions in the presence of catalysts having different lanthanum content; and

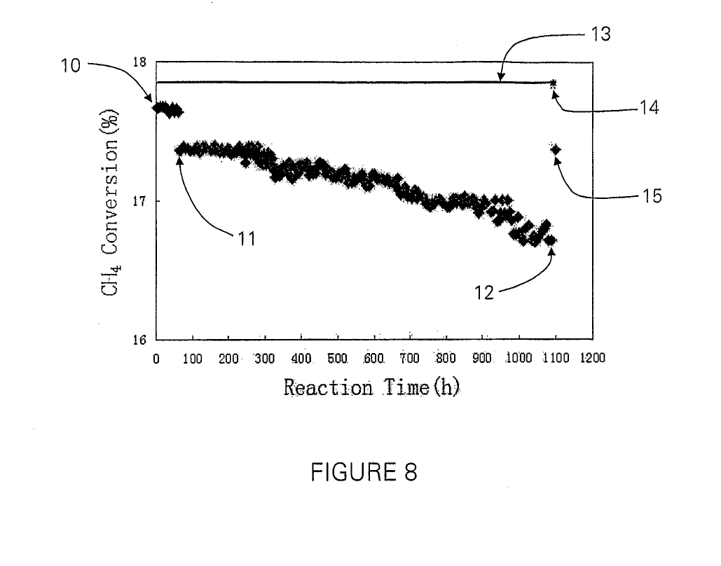

FIG. 8 is a plot of catalytic activity of a catalyst over 1000 hours on stream.

### EXAMPLE 1

A steam reforming catalyst comprising Ni, La, Mg and Al was synthesised by the following procedure.

50.944 g Ni(NO₃)₂.6H₂O, 161.032 g Al(NO₃)₃.9H₂O and 3.794 g La(NO₃)₃.4H₂O were dissolved in 500 mL de-ionised water. 180 mL 25% ammonium solution was diluted to 500 mL and added to the first solution under vigorous stirring, while maintaining a pH of between 8 and 8.5. A precipitate formed which was aged for 2 to 4 hours before being filtered and washed with deionised water. The precipitate was suspended in deionised water, 13.155 g (MgCO₃)₄.Mg(OH)₂.5H₂O were added, and the mixture stirred for 10 minutes. The resulting solid was dried overnight in air at 120° C. It was then calcined at 900° C. for 6 hours in air.

The composition of the resulting material, as determined by X-Ray fluorescence, was 25.7% Ni, 54.7% Al₂O₃, 4.2% La₂O₃ and 14.6% MgO by weight.

### EXAMPLE 2

A catalyst was made using the recipe of example 1, except that the following quantities of materials were used: 28.738 g Ni(NO₃)₂.6H₂O, 195.322 g Al(NO₃)₃.9H₂O and 4.091 g La(NO₃)₃.4H₂O. The resulting composition was 15.9% Ni, 72.5% Al₂O₃, 4.6% La₂O₃ and 6.7% MgO by weight.

### EXAMPLE 3

A catalyst was made using the recipe of example 1, except that the following quantities of materials were used: 36.269 g Ni(NO₃)₂.6H₂O, 183.850 g Al(NO₃)₃.9H₂O and 4.182 g La(NO₃)₃.4H₂O. The resulting composition was 18.3% Ni, 66.5% Al₂O₃, 4.6% La₂O₃ and 10.4% MgO by weight.

### EXAMPLE 4

A catalyst was made using the recipe of example 1, except that the following quantities of materials were used: 40.828 g Ni(NO₃)₂.6H₂O, 178.261 g Al(NO₃)₃.9H₂O and 3.818 g La(NO₃)₃.4H₂O. The resulting composition was 20.6% Ni, 64.5% Al₂O₃, 4.2% La₂O₃ and 10.5% MgO by weight.

### EXAMPLE 5

A catalyst was made using the recipe of example 1, except that the following quantities of materials were used: 46.576 g Ni(NO₃)₂.6H₂O, 169.436 g Al(NO₃)₃.9H₂O and 3.912 g La(NO₃)₃.4H₂O. The resulting composition was 23.5% Ni, 62.4% Al₂O₃, 4.3% La₂O₃ and 9.6% MgO by weight.

### EXAMPLE 6

A catalyst was made using the recipe of example 1, except that the following quantities of materials were used: 62.233 g Ni(NO₃)₂.6H₂O, 147.668 g Al(NO₃)₃.9H₂O and 3.455 g La(NO₃)₃.4H₂O. The resulting composition was 31.4% Ni, 51.1% Al₂O₃, 3.8% La₂O₃ and 13.2% MgO by weight.

### EXAMPLE 7

A catalyst was made using the recipe of example 1, except that the following quantities of materials were used: 12.737 g Ni(NO₃)₂.6H₂O, 40.330 g Al(NO₃)₃.9H₂O and 0.948 g La(NO₃)₃.4H₂O. No magnesium compound was added. The resulting composition was 32.3% Ni, 62.2% Al₂O₃, 5.0% La₂O₃ and 0% MgO by weight.

### EXAMPLE 8

A catalyst was made using the recipe of example 1, except that the following quantities of materials were used: 55.484 g Ni(NO₃)₂.6H₂O, 181.002 g Al(NO₃)₃.9H₂O, 2.770 g La(NO₃)₃.4H₂O and 5.994 g (MgCO₃)₄.Mg(OH)₂.5H₂O. The resulting composition was 28.0% Ni, 61.5% Al₂O₃, 3.1% La₂O₃ and 6.5% MgO by weight.

### EXAMPLE 9

A catalyst was made using the identical recipe of example 1. The resulting composition was 25.7% Ni, 54.7% Al₂O₃, 4.2% La₂O₃ and 14.6% MgO by weight.

### EXAMPLE 10

A catalyst was made using the recipe of example 1, except that the following quantities of materials were used: 50.944 g Ni(NO₃)₂.6H₂O, 147.462 g Al(NO₃)₃.9H₂O, 3.794 g La(NO₃)₃.4H₂O and 17.679 g (MgCO₃)₄.Mg(OH)₂.5H₂O. The resulting composition was 28.4% Ni, 49.4% Al₂O₃, 4.8% La₂O₃ and 17.1% MgO by weight.

### EXAMPLE 11

A catalyst was made using the recipe of example 1, except that the following quantities of materials were used: 50.944 g Ni(NO₃)₂.6H₂O, 147,462 g Al(NO₃)₃.9H₂O, 3.794 g La(NO₃)₃.4H₂O and 17.978 g (MgCO₃)₄.Mg(OH)₂.5H₂O. The resulting composition was 25.8% Ni, 50.3% Al₂O₃, 4.2% La₂O₃ and 19.7% MgO by weight.

### EXAMPLE 12

A catalyst was made using the recipe of example 1, except that no La(NO₃)₃.4H₂O was added, and the following quantities of materials were used: 25.472 g Ni(NO₃)₂.6H₂O, 80.516 g Al(NO₃)₃.9H₂O and 6.578 g (MgCO₃)₄.Mg(OH)₂.5H₂O. The resulting composition was 30.5% Ni, 57.9% Al₂O₃, 0.1% La₂O₃ and 11.4% MgO by weight.

### EXAMPLE 13

A catalyst was made using the recipe of example 1, except that the following quantities of materials were used: 25.472 g Ni(NO₃)₂.6H₂O, 80.516 g Al(NO₃)₃.9H₂O, 0.948 g La(NO₃)₃.4H₂O and 6.578 g (MgCO₃)₄.Mg(OH)₂.5H₂O. The resulting composition was 29.2% Ni, 55.3% Al₂O₃, 2.3% La₂O₃ and 13.2% MgO by weight.

### EXAMPLE 14

A catalyst was made using the identical recipe of example 1. The resulting composition was 25.7% Ni, 54.7% Al₂O₃, 4.2% La₂O₃ and 14.6% MgO by weight.

### EXAMPLE 15

A catalyst was made using the recipe of example 1, except that the following quantities of materials were used: 25.472 g Ni(NO₃)₂.6H₂O, 80.516 g Al(NO₃)₃.9H₂O, 2.845 g La(NO₃)₃.4H₂O and 6.578 g (MgCO₃)₄.Mg(OH)₂.5H₂O. The resulting composition was 28.1% Ni, 53.3% Al₂O₃, 6.9% La₂O₃ and 12.5% MgO by weight.

### EXAMPLE 16

A catalyst was made using the recipe of example 1, except that the following quantities of materials were used: 25.472 g Ni(NO₃)₂.6H₂O, 80.516 g Al(NO₃)₃.9H₂O, 5.690 g La(NO₃)₃.4H₂O and 6.578 g (MgCO₃)₄.Mg(OH)₂.5H₂O. The resulting composition was 27.5% Ni, 48.6% Al₂O₃, 11.7% La₂O₃ and 10.5% MgO by weight.

### EXAMPLE 17

A catalyst was made using the recipe of example 1, except that magnesium nitrate was the source of magnesium, and the following quantities of materials were used: 42.87 g Ni(NO₃)₂.6H₂O, 171.51 g Al(NO₃)₃.9H₂O, 2.27 g La(NO₃)₃.4H₂O and 37.73 g Mg(NO₃)₂.6H₂O. The resulting composition was 25.2% Ni, 57.6% Al₂O₃, 2.8% La₂O₃ and 14.4% MgO by weight.

### EXAMPLE 18

A catalyst was made using the recipe of example 1, except that magnesium oxide was the source of magnesium, and the following quantities of materials were used: 50.944 g Ni(NO₃)₂.6H₂O, 147.462 g Al(NO₃)₃.9H₂O, 3.794 g La(NO₃)₃.4H₂O and 37.73 g (MgCO₃)₄.Mg(OH)₂.5H₂O. The resulting composition was 29.1% Ni, 54.5% Al₂O₃, 4.4% La₂O₃ and 12.0% MgO by weight.

Table 1 summarises the compositions of the catalysts described in examples 1 to 16. FIG. 1 shows X-ray diffraction patterns of the catalysts after calcination of (a) example 1, (b) example 2, (c) example 3, (d) example 4, (e) example 5 and (f) example 6. Peaks 1 are due to the presence of a spinel phase. Additional peaks 2 are due to a NiO phase which occurs above a certain nickel loading in the catalyst. The patterns show that, below a particular nickel loading, any nickel oxide particles are less than 4 nm in diameter, indicating that the nickel is contained within the spinel structure and/or is contained in NiO particles of less than about 4 nm in diameter, indicating high dispersion throughout the spinel structure. At nickel loadings of above about 24-25% by weight, a separate NiO phase is apparent, which indicates that NiO particles above about 4 nm in diameter begin to form.

FIG. 2 compares X-ray diffraction patterns of the catalyst of example 1 after calcination (a) and after use in a steam reforming experiment (b). The NiO phase disappears from the calcined catalyst, and instead nickel(0) particles are apparent, as shown by new peaks 3. A further nickel peak (not shown) overlaps with the spinel reflection at a 2-theta value of 45°. The nickel(0) particles in this example are greater than about 4 nm in diameter due to the appearance of peaks on the XRD pattern. Peaks due to the presence of Ni(0) are also seen in MUD patterns of the catalysts of examples 1 and 2 after reduction at 780° C.

### EXPERIMENTS ON CATALYTIC ACTIVITY

Samples of powdered calcined catalyst were pressed into a disk at 25 MPa pressure, which were then crushed and sieved to a 16-30 mesh particle size.

2 g of the crushed and sieved catalyst were diluted with 10 g MgAl₂O₄ and loaded into a fixed bed continuous flow stainless steel reactor with an inner diameter of 14 mm and 500 mm length, giving a catalyst bed length of approximately 50 mm.

The catalyst was reduced at 800° C. in a stream comprising 10% hydrogen by volume in argon at 200 mL/min for 3 hours before the experiments were started.

TABLE 1
Catalyst Compositions

| Example | Ni (wt %) | Al₂O₃ (wt %) | La₂O₃ (wt %) | MgO (wt %) |
|---|---|---|---|---|
| 1 | 25.7 | 54.7 | 4.2 | 14.6 |
| 2 | 15.9 | 72.5 | 4.6 | 6.7 |
| 3 | 18.3 | 66.5 | 4.6 | 10.4 |
| 4 | 20.6 | 64.5 | 4.2 | 10.5 |
| 5 | 23.5 | 62.4 | 4.3 | 9.6 |
| 6 | 31.4 | 51.1 | 3.8 | 13.2 |
| 7 | 32.3 | 62.2 | 5.0 | 0.0 |
| 8 | 28.0 | 61.5 | 3.1 | 6.5 |
| 9 | 25.7 | 54.7 | 4.2 | 14.6 |
| 10 | 28.4 | 49.4 | 4.8 | 17.1 |
| 11 | 25.8 | 50.3 | 4.2 | 19.7 |
| 12 | 30.5 | 57.9 | 0.1 | 11.4 |
| 13 | 29.2 | 55.3 | 2.3 | 13.2 |
| 14 | 25.7 | 55.3 | 4.2 | 14.6 |
| 15 | 28.1 | 53.3 | 6.9 | 12.5 |
| 16 | 27.5 | 48.6 | 11.7 | 10.5 |
| 17 | 25.2 | 57.6 | 2.8 | 14.4 |
| 18 | 29.1 | 54.5 | 4.4 | 12.0 |

### Experiment 1

The reduced catalyst of Example 1 was contacted with methane and steam at a pressure of 0.9 MPa (absolute) and at temperatures of 723, 773 and 823 K. The molar ratio of water to methane was 3. Methane gas hourly space velocities (GHSV—mL[CH₄]/mL[catalyst]/h) in the range of from 2000 to 24000 h⁻¹ were used. Results are listed in table 2.

The results show that high conversions are obtainable, with equilibrium conversions being achieved even at very high space velocities, which is indicative of high catalyst activity. This is even the case at low temperatures, demonstrating suitability of the catalyst for low temperature reforming reactions.

TABLE 2
Catalytic activity at different temperature and methane GHSV.

| | | Dry composition of | | | | |
|---|---|---|---|---|---|---|
| Temp | CH₄ GHSV | reformate (vol %) | | | | CH₄ |
| (K) | (h⁻¹) | H₂ | CO | CH₄ | CO₂ | conversion (%) |
| 723 | Equilibrium^{a} | 34.91 | 0.22 | 58.02 | 8.56 | 13.14 |
| | 2000 | 31.40 | 0.20 | 59.58 | 8.82 | 13.15 |
| | 4000 | 33.87 | 0.27 | 57.47 | 8.39 | 13.1 |
| | 8000 | 34.18 | 0.19 | 57.15 | 8.47 | 13.17 |
| | 16000 | 33.62 | 0.19 | 57.65 | 8.54 | 13.16 |
| | 24000 | 32.10 | 0.13 | 59.93 | 7.84 | 11.74 |
| 773 | Equilibrium^{a} | 43.30 | 0.61 | 45.72 | 10.37 | 19.36 |
| | 2000 | 43.40 | 0.60 | 45.63 | 10.37 | 19.38 |
| | 4000 | 43.83 | 0.59 | 45.29 | 10.30 | 19.38 |
| | 8000 | 43.50 | 0.56 | 45.57 | 10.37 | 19.36 |
| | 16000 | 43.54 | 0.54 | 45.54 | 10.38 | 19.34 |
| | 24000 | 42.53 | 0.49 | 46.61 | 10.36 | 18.89 |
| 823 | Equilibrium^{a} | 51.54 | 1.46 | 35.21 | 11.79 | 27.33 |
| | 2000 | 51.16 | 1.40 | 35.41 | 12.03 | 27.49 |
| | 4000 | 51.05 | 1.35 | 35.58 | 12.03 | 27.33 |
| | 8000 | 51.38 | 1.36 | 35.32 | 11.92 | 27.34 |
| | 16000 | 52.06 | 1.20 | 34.84 | 11.90 | 27.33 |
| | 24000 | 51.15 | 1.10 | 35.06 | 12.15 | 27.14 |

^{a}Calculated equilibrium conversions under the reaction conditions employed.

### Experiment 2

Catalysts of examples 1, 2, 4, 5 and 6 were tested at 823K at 0.9 MPa pressure using natural gas as the source of methane. The water:methane mole ratio was 3, with methane space velocities of 4000 to 20000 h⁻¹. Results are listed in table 3 and illustrated in FIGS. 3 and 4.

In FIG. 3, catalytic activity for the catalysts of Example 2 (♦), Example 4 (□), Example 5 (x), Example 1 (▴) and Example 6 (∘) are plotted against methane GHSV. In FIG. 4, catalytic activity of the catalysts is plotted against nickel loading at a methane GHSV of 20 000 h⁻¹. These experiments show that activity increases with nickel loading up to a certain value, above which the activity seems to remain unchanged.

TABLE 3
Catalytic activity of catalysts with different nickel loadings.

| CH₄ | CH₄ conversion (%) | | | | |
|---|---|---|---|---|---|
| GHSV | Example 2 | Example 4 | Example 5 | Example 1 | Example 6 |
| (h⁻¹) | (15.9% Ni) | 20.6% Ni | 23.5% Ni | 25.7% Ni | 31.4% Ni |
| 4000 | 27.36 | 27.35 | 27.34 | 27.35 | 27.35 |
| 8000 | 26.93 | 27.35 | 27.34 | 27.35 | 27.35 |
| 12000 | 25.66 | 26.13 | 27.34 | 27.35 | 27.34 |
| 16000 | 24.13 | 25.13 | 26.39 | 26.57 | 26.51 |
| 20000 | 22.75 | 24.23 | 25.55 | 25.86 | 25.77 |

### Experiment 3

Catalytic experiments were conducted on the catalysts of Examples 7 to 11 under the same conditions as those used for Experiment 2, using natural gas as the source of methane. Results are listed in Table 4 and illustrated in FIG. 5.

In FIG. 5, catalytic activity for the catalysts of Example 7 (♦), Example 8 (□), Example 9 (x), Example 10 (▴) and Example 11 (∘) are plotted against methane GHSV. The results show that methane conversions are improved when magnesium is present in the catalyst composition, although only up to levels of about 14 to 15 wt %, above which there does not appear to be any significant increase in activity.

TABLE 4
Catalytic activity versus magnesium content

| CH₄ | CH₄ conversion (%) | | | | |
|---|---|---|---|---|---|
| GHSV | Example 7 | Example 8 | Example 9 | Example 10 | Example 11 |
| (h⁻¹) | 0% Mg | 6.5% Mg | 14.6% Mg | 17.1% Mg | 19.7% Mg |
| 4000 | 27.35 | 27.35 | 27.35 | 27.35 | 27.35 |
| 8000 | 27.35 | 27.35 | 27.35 | 27.35 | 27.35 |
| 12000 | 27.00 | 26.97 | 27.35 | 27.18 | 27.25 |
| 16000 | 26.06 | 26.24 | 26.57 | 26.42 | 26.35 |
| 20000 | 25.00 | 24.49 | 25.86 | 25.62 | 25.72 |

### Experiment 4

Catalytic experiments were conducted on the catalysts of Examples 11, 17 and 18 under the same conditions as those used for Experiment 2, using natural gas as the source of methane. Results are listed in table 5 and plotted in FIG. 6.

In FIG. 6, catalytic activity for the catalysts of Example 11 (∘), Example 17 (▴), and Example 18 (x) are plotted against methane GHSV. The results show that using magnesium carbonate as the source of magnesium provides a catalyst with higher activity compared to the use of other salts such as magnesium nitrate or magnesium oxide as the source of magnesium.

TABLE 5
Activity of catalysts prepared using different magnesium compounds.

| CH₄ | CH₄ conversion (%) | | |
|---|---|---|---|
| GHSV | Example 18 | Example 17 | Example 11 |
| (h⁻¹) | (MgO) | (Mg(NO₃)₂ | Mg(CO₃) |
| 4000 | 27.35 | 27.35 | 27.35 |
| 8000 | 27.35 | 27.35 | 27.35 |
| 12000 | 26.63 | 26.72 | 27.35 |
| 16000 | 25.55 | 25.57 | 27.61 |
| 20000 | 24.62 | 24.67 | 25.84 |

### Experiment 5

The catalysts of Examples 10 to 14 were studied under the same conditions as used in Experiments 2 and 3, using natural gas as the source of methane. Results are listed in Table 6 and plotted in FIG. 7.

TABLE 6
Catalytic activity versus lanthanum content of the catalyst.

| | CH₄ conversion (%) | | | | |
|---|---|---|---|---|---|
| | Example | Example | Example | Example | Example |
| CH₄ GHSV | 10 | 11 | 12 | 13 | 14 |
| (h⁻¹) | 0.1% La | 2.3% La | 4.2% La | 6.9% La | 11.7% La |
| 4000 | 27.35 | 27.35 | 27.35 | 27.35 | 27.35 |
| 8000 | 27.35 | 27.35 | 27.35 | 27.35 | 27.35 |
| 12000 | 27.05 | 27.35 | 27.35 | 27.35 | 27.35 |
| 16000 | 26.39 | 26.56 | 26.61 | 26.62 | 26.64 |
| 20000 | 25.49 | 25.88 | 25.84 | 25.72 | 25.91 |

In FIG. 7, catalytic activity for the catalysts of Example 10 (♦), Example 11 (□), Example 12 (x), Example 13 (▴) and Example 14 (∘) are plotted against methane GHSV. The results demonstrate that the presence of lanthanum in the catalyst increases methane conversions.

### Experiment 6

The catalyst of Example 1 was evaluated at 823K, 2.0 MPa pressure, a water:methane mole ratio of 2.5, and natural gas as the source of methane. With reference to FIG. 8, an initial GHSV of 35000 h⁻¹ gave methane conversion of 17.65%, as indicated at data point 10. Increasing the methane GHSV to 40000 h⁻¹ caused a drop in conversion to a value of 17.37%, as indicated by data point 11. These conditions were maintained over a period of 1030 hours on stream. Towards the end of the 1030 hours, conversion was 16.79%, as indicated at data point 12. The GHSV was then reduced to 30000 h⁻¹ which resulted in an increase of the conversion to the equilibrium value 13 of 17.85%, as indicated by data point 14. Restoring the methane GHSV to 40000 h⁻¹ and increasing the temperature from 823 to 827K, as indicated by data point 15, resulted in methane conversions being the same as those observed at the start of the 1030 hour run at the same methane GHSV, i.e. at point 11. These results demonstrate that catalytic activity is maintained over a considerable period of time-on-stream, and they also demonstrate that any drop in methane conversion can be compensated by reducing the methane GHSV and/or by increasing the reaction temperature.

### Experiment 7

The crush strength of pressed discs of catalyst prepared according to Example 1, and the same catalyst after reduction in a stream of hydrogen were compared. Tests were performed on discs of 10 mm diameter and 1.5 to 2 mm thickness that were prepared by subjecting a powdered sample to a pressure of 25 MPa. Crush strengths were carried out on the edges of the discs, in which the flat surfaces of the discs were disposed vertically during the measurement. The maximum pressure that could be exerted by the apparatus was 400N. Results are shown in Table 7.

The results demonstrate that the catalyst strength does not appear to deteriorate when the catalyst undergoes reduction to produce metal(0) particles.

TABLE 7
Crush Strength Measurements

| Crush Strength | Crush Strength |
|---|---|
| After Calcination (N) | After Reduction (N) |
| 280 | 350 |
| >400 | >400 |
| 350 | >400 |
| >400 | >400 |

1-51. (canceled)

52. A catalyst composition suitable for the conversion of a hydrocarbon to hydrogen and one or more oxides of carbon, which catalyst is crystalline and comprises the elements nickel, magnesium, aluminium and a lanthanide element, wherein the crystalline phase is a spinel phase.

53. A catalyst composition as claimed in claim 52, in which the lanthanide element is lanthanum.

54. A catalyst composition as claimed in claim 52, in which the nickel loading is greater than 15% by weight.

55. A catalyst composition as claimed in claim 54, in which the nickel loading is in the range of from greater than 15% to 35% by weight.

56. A catalyst composition as claimed in claim 52, in which the aluminium content, expressed as Al₂0₃, is in the range of from 20 to 80 wt %.

57. A catalyst composition as claimed in claim 56, in which the aluminium content is in the range of from 40 to 70 wt %.

58. A catalyst composition as claimed in claim 52, in which the lanthanum content, expressed as La₂O₃, is greater than 0.1 wt %.

59. A catalyst composition as claimed in claim 58, in which the lanthanum content is greater than 1 wt %.

60. A catalyst composition as claimed in claim 59, in which the lanthanum content is in the range of from 2 to 12 wt %.

61. A catalyst as claimed in claim 52, in which the magnesium content, expressed as MgO, is greater than 5 wt %.

62. A catalyst as claimed in claim 61, in which the magnesium content is in the range of from 6 to 25 wt %.

63. A catalyst as claimed in claim 52, in which the nickel is present in particles of less than 4 nm in diameter.

64. A catalyst as claimed in claim 52, in which the nickel is in the form of nickel(0).

65. A method of producing a steam reforming catalyst comprising the steps of:
(i) Providing a solution or suspension comprising a catalyst metal active for the conversion of a hydrocarbon to hydrogen and one or more oxides of carbon, and a refractory oxide or precursor thereof;
(ii) Producing a precipitate comprising the catalyst metal and refractory oxide;
(iii) Separating the precipitate of step (ii) from the solution or suspension; and
(iv) heating the separated precipitate of step (iii) under an oxygen-containing atmosphere to a temperature at which a crystalline phase is formed having highly dispersed catalyst metal;
wherein the precipitate comprising catalyst metal and refractory oxide in step (ii) is obtained by treating the solution or suspension of step (i) with a precipitant.

66. A method as claimed in claim 65, in which the precipitant is a base.

67. A method as claimed in claim 66, in which the base is selected from one or more of ammonia, ammonium hydroxide, ammonium carbonate, an alkali metal hydroxide or carbonate, and an alkaline earth metal hydroxide or carbonate.

68. A method as claimed in claim 65, in which the refractory oxide is selected from one or more of alumina, silica, zirconia and an alkaline earth metal oxide.

69. A method as claimed in claim 68, in which the refractory oxide is selected from magnesium oxide and/or aluminium oxide.

70. A method as claimed in claim 65, in which a promoter is additionally added to the catalyst.

71. A method as claimed in claim 70, in which the promoter is an alkali metal or a lanthanide.

72. A method as claimed in claim 71, in which the promoter is a lanthanide.

73. A method as claimed in claim 72, in which the promoter is lanthanum.

74. A method as claimed in claim 65, in which in step (i) a refractory oxide precursor compound, a catalyst metal-containing compound and optional promoter-containing compound are present either as miscible liquids, or are dissolved in a solvent to form a homogeneous liquid phase, before the precipitant is added.

75. A method as claimed in claim 65, in which one or more of the promoter, refractory oxide or precursor thereof, or catalyst metal is added to the precipitate produced in step(iii) before calcination.

76. A method as claimed in claim 75, in which magnesium oxide or precursor thereof is the refractory oxide or one of the refractory oxides, and is added to the precipitate of step (iii) before calcination.

77. A method as claimed in claim 65, in which the catalyst metal is selected from one or more of nickel. ruthenium, platinum, palladium, rhodium, rhenium and iridium.

78. A method as claimed in claim 77, in which the catalyst metal is nickel.

79. A method as claimed in claim 78, in which the nickel loading of the catalyst is greater than 15 wt %.

80. A method as claimed in claim 65, in which the solutions or suspensions have water or a polar organic compound as solvent.

81. A method as claimed in claim 80, in which the solvent is water.

82. A method as claimed in claim 65, in which the calcination is carried out at a temperature greater than 700° C.

83. A method as claimed in claim 65, in which the crystalline phase is a spinel phase.

84. A method as claimed in claim 65, in which any catalyst metal-containing particles in the catalyst after calcination are less than about 4 nm in diameter.

85. A method as claimed in claim 65, in which the catalyst, after calcination, is reduced to form metal(0) species.

86. A method as claimed in claim 85, in which the catalyst is reduced in the presence of a hydrogen-containing gas.

87. A method as claimed in claim 76, in which the catalyst is in accordance with claim 52.

88. A process for the conversion of a hydrocarbon to hydrogen and one or more oxides of carbon comprising contacting the hydrocarbon and either steam or oxygen or both with a catalyst, which catalyst comprises a catalyst metal active for the conversion of the hydrocarbon to hydrogen and oxides of carbon, and a refractory oxide, wherein the catalyst has a spinel structure.

89. A process as claimed in claim 88, in which the hydrocarbon conversion reaction is a steam reforming reaction.

90. A process as claimed in claim 88, in which the catalyst metal is selected from one or more of nickel, ruthenium, platinum, palladium, rhodium, rhenium and iridium.

91. A process as claimed in claim 90, in which the catalyst metal is nickel.

92. A process as claimed in claim 91, in which the nickel loading is greater than 15 wt %.

93. A process as claimed in claim 88, in which the refractory oxide is selected from one or more of alumina, silica, zirconia and an alkaline earth metal oxide.

94. A process as claimed in claim 93, in which the refractory oxide is alumina and/or magnesium oxide.

95. A process as claimed in claim 88, in which the catalyst additionally comprises a promoter.

96. A process as claimed in claim 95, in which the promoter is selected from one or more alkaline metal or lanthanide elements.

97. A process as claimed in claim 96, in which the promoter is a lanthanide.

98. A process as claimed in claim 97, in which the promoter is lanthanum.

99. A process as claimed in claim 88, in which the hydrocarbon is methane.

100. A process as claimed in claim 88, in which the reaction temperature is 700° C. or less, and the pressure is in the range of up to 200 bara (20 MPa).

101. A process as claimed in claim 88, in which the pressure is in the range of from 1 to 90 bara (0.1 to 9 MPa).

102. A process as claimed in claim 88, in which the catalyst is a catalyst according to claim 52.
